(19) United States
(12) Patent Application Publication
(10) Pub. No.: US 2009/0064508 A1
(43) Pub. Date: Mar. 12, 2009

(54) Hand held sharpening device

(76) Inventor: Horacio Masseilot, Buenos Aires (AR)

Correspondence Address: Victor Abruzzese, 2980 Briggs Ave. Apt. 6E, Bronx, NY, 10458, US

(21) Appl. No.: 12/229,370

(22) Filed: Aug. 22, 2008

(30) Foreign Application Priority Data
Aug. 30, 2007 (AR) 20070103851

(51) Int. Cl. B26B 9/00; B22F 7/04

(52) U.S. Cl. 30/350; 419/18; 30/357

(57) ABSTRACT

This invention is a manual sharpening device for knife blades that creates a micro-serrated edge on the cutting edge of a knife (microscopic saw). There are two types of knife blades on the world market: plain (flat cutting surface) and serrated (undulated cutting surface, also known as saw knives). Each has a wide range of shapes and sizes for various applications. This sharpening tool allows the user to create a cutting edge on any knife that combines the effects of the plain and serrated edge and thereby expands the potential applications of any knife.

### CROSS REFERENCE TO RELATED APPLICATION

Not Applicable

### STATEMENT REGARDING FEDERAL SPONSORSHIP

Not Applicable

### NAMES OF PARTIES TO JOINT RESEARCH AGREEMENT

Not Applicable

### REFERENCE TO A SEQUENCE LISTING

Not Applicable

### BACKGROUND OF THE INVENTION

This invention relates to a hand-held sharpening device, more precisely to a manual device for sharpening knife blades. There are two types of knife blades on the world market: plain (flat cutting surface) and serrated (undulated cutting surface, also known as saw knives); having each a wide range of shapes and sizes. Each thing to be cut will be more or less clearly favored by one of these. As an example we know that meat is best cut with a plain edge knife and bread with a serrated-edge knife.

This sharpening tool creates a micro-serrated edge (7) on the cut-surface (microscopic saw) where the effects of the plain and serrated blades are combined. This makes the penetration of the knife easier, which becomes even more noticeable when the thing is more “difficult” to cut.

There are surfaces which usually present difficulties at the time of cutting, one of which is, for example, the tomato skin. However, even using a low quality knife sharpened with this tool, the cut of a tomato of any variety will be made without any difficulty even in thin slices, which indicates the little pressure made in the cut. The “secret” consists in that the pressure made on the knife will not be applied on a continuous blade whose big contact surface tends to “squish” the thing to be cut, but which will be microscopic sharpened segments, which like points, will “prick” the object making it easier for the knife to penetrate it. Such penetration will clearly happen with a lower pressure in the cut compared to a traditional sharpening. With this invention we can achieve a serrated knife cutting edge and therefore the advantages mentioned above.

### BRIEF SUMMARY OF THE INVENTION

The Hand Held Sharpening Device is a manual device for the sharpening of knife blades made up of a handle used as a support element in whose inferior part a portion of a metallic blade is fitted, which has a straight edge in its external part partially covered by an abrasive powder which is strongly adhered to such edge.

### BRIEF DESCRIPTION OF THE SEVERAL VIEWS OF THE DRAWING

FIG. 1: Illustrates a side elevational view of the Hand Held Sharpening Device.

FIG. 2: Illustrates a plan view from above the Hand Held Sharpening Device.

FIG. 3: Illustrates a view of cut III, which is indicated in FIG. 1.

FIG. 4: Illustrates a detail of the cutting edge obtained with the Hand Held Sharpening Device.

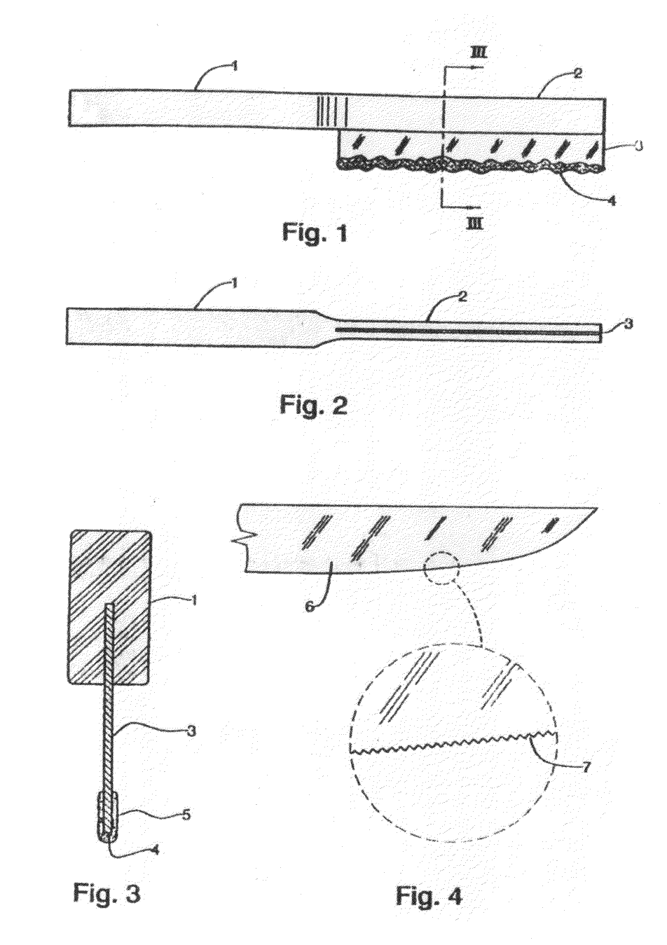

### DETAILED DESCRIPTION OF THE INVENTION

The Hand-Held Sharpening Device characterized in that it comprises a part as a clamping means fixed to a longiform support element in which a portion of a blade is fitted which has a straight edge in its external part partially covered with an abrasive powder (3) strongly adhered to such edge. The sharpener of this invention is composed of a handle (1), which prolongs into an element (2) of support of a blade (3) which is partially fitted in such support element (2). The handle (1) has a functional shape to grip the device tightly and the material which the handle (1) as well as the support element (2) are made of has to be of a rigidity similar to that of wood or the plastic material used in this kind of tools. The blade (3) has an undulated (4) edge which is partially covered with an abrasive powder (5) strongly adhered to such edge. The abrasive powder (5) is preferably tungsten carbide powder with variable grits and the preferred method to achieve adherence to the blade (3) is by means of sinterization.

The invention claimed is:

1. A HAND HELD SHARPENING DEVICE, characterized by being made of a long handle to which a small blade is inserted into the underside of one end of the handle and having the exposed edge of the blade covered with an abrasive powder.

2. THE HAND HELD SHARPENING DEVICE, according to claim 1, characterized by an abrasive powder made of tungsten carbide with variable grits.

3. THE HAND HELD SHARPENING DEVICE, according to claim 1, characterized by said abrasive powder adhering to the edge of the blade by sinterization.
